(19) United States
(12) Patent Application Publication
(10) Pub. No.: US 2002/0120746 A1
(43) Pub. Date: Aug. 29, 2002

(54) Method and system for providing a service

(76) Inventors: Basavaraj Patil, Coppell, TX (US); Khiem Le, Coppell, TX (US); Stefano Faccin, Texas, TX (US); Curt Wong, Plano, TX (US); Srinivas Sreemanthula, Arlington, TX (US); Jari Mutikainen, Irving, TX (US); Kengatharan Sivalingam, Irving, TX (US)

Correspondence Address: HAHN LOESER & PARKS, LLP, TWIN OAKS ESTATE, 1225 W. MARKET STREET, AKRON, OH, 44313, US

(21) Appl. No.: 09/792,706

(22) Filed: Feb. 23, 2001

(51) Int. Cl. G06F 15/16

(52) U.S. Cl. 709/227

(57) ABSTRACT

The present invention relates to a method and system for providing a service in a communication network. A service script is used to control a service execution functional unit to execute the service, wherein an execution priority is allocated to the service script based on the kind of service. Furthermore, a service logic of the service may be provided at a service execution functional unit, and the service script may comprise a service description of the service. The service execution functional unit is then controlled based on the service description to execute the service by using the service logic. Thus, the service script does not contain the service logic, and a flexible service script concept can be provided. Moreover, the signaling traffic can be reduced since the operator does not have to update service scripts for a large amount of subscribers.

### FIELD OF THE INVENTION

The present invention relates to a method and system for providing a service, e.g. an IP-based service such as VolP (Voice over IP), multimedia, e-mail, instant messaging, WEB browsing, WAP and the like, in a communication network, e.g. an IP-based network.

### BACKGROUND OF THE INVENTION

In a communication environment, service scripts provide a means to create and manage value added services in a centralized session but distribute fully the service execution. The service logic is defined with a script which can be moved between functional elements in a communication network and which is executed in a suitable functional element. Usable script languages can be, for example, CPL (Call Processing Language), SIP Servlets (SIP:Session Initiation Protocol) representing executable instructions which handle SIP messages, or CGI (Common Gateway Interface).

The CPL language scripts are distributed to the servers participating in the handling of calls that need to be effected using these supplementary services. The scripts are inserted to these servers by the network management system, end-users or administrators. There can be several CPL script instances participating to the handling of a given call. The individual script instances are triggered and executed on signaling events conforming to predefined trigger conditions such as caller or callee identification. For example, when there is an incoming call to a subscriber who has defined an incoming call screening script, the script is executed because the callee identification matches.

In general, service scripts provide an efficient, portable and powerful tool for executing control instructions in a distributed network. Service scripts are for example used in Internet Web pages to create different kinds of effects for users. A service script can be transferred or downloaded from e.g. a Web server to the local computer and executed there.

Moreover, using CPL scripts in connection with SIP Invite messages provides an opportunity to execute services in proxy nodes as specified by a user in an IN (Intelligent Network) network type.

However, due to the fact that the service scripts are stored and executed at a plurality of call control functional units or servers, especially in case of widely used services, a high amount of signaling is required to update service scripts or to adapt service scripts to new service features. Additionally, the fast evolution of IP (Internet Protocol) networks leads to an increased range of services or user-specific services leading to a demand for a higher flexibility of creating and configuring new services in the network with minimal disruption.

### SUMMARY OF THE INVENTION

It is therefore an object of the present invention to provide an improved method and system for providing a service with higher flexibility and lower network disruption.

This object is achieved by a method for providing a service in a communication network, the method comprising the steps of: generating a service script comprising a service description of a service; providing a service logic of the service at a service execution functional unit; and controlling the service execution functional unit based on the service description to execute the service by using the service logic.

Furthermore, the above object is achieved by a system for providing a service in a communication network, the system comprising:

generating means for generating a service script comprising a service description of the service;

service execution means comprising a service logic for executing the service; and

service execution management means for controlling the service execution means based on the service description to execute the service by using the service logic.

Accordingly, service scripts can be generated independent from the service logic at the service execution functional unit. Due to the fact that the service is defined by a service description and not by the service logic, a lot of flexibility is given to a user or the network operator to the initiate service creation and configuration, which will be demanded by advanced next generation services. It provides a level of control to the user that is not yet available. The user is capable of customizing services based on his preferences with minimal intervention by the network operator or service provider. No restrictions are given on how the service logic can be implemented, such that the service logic can be defined in any language or form and is not limited to the scripts. Furthermore, the service execution functional unit not necessarily has to be provided in a call processing server and can take various forms and use various protocols. Moreover, services may be provided even through a service execution functional units of third party networks, which are no call processing servers.

Additionally, the above object is achieved by a method for providing a service in a communication network, the method comprising the steps of: generating a service script defining the service, controlling a service execution functional unit based on the service script to execute the service, and allocating an execution priority for the service script based on the kind of service. Furthermore, the above object is achieved by a system for providing a service in a communication network, the system comprising:

generating means for generating a service script comprising a service description of the service;

service execution management means for controlling service execution means based on the service description to execute the service; and

allocating means for allocating an execution priority to the service script based on the kind of the service.

Accordingly, service execution is performed according to priority rules by using the service scripts. Thereby, the service scripts can be executed in a predefined order. The scripts have a priority and define what kind of services can or can't be used. E.g. highest priority is given to a script which has an ID (e.g. phone number) of stolen mobiles, meaning that those mobiles can't have any kind of service. The use of priorities and different kinds of service scripts increase the flexibility of service provision and reduces the number of scripts to be updated to those with the highest priority if lower priority scripts are not executed.

Preferably, the service script is stored at a service execution management functional unit, wherein a call from a call control functional unit is routed to the service execution management functional unit, and the service is invoked by the service execution management functional unit based on the service description. Thereby, the call control function is separated from the service execution management function to thereby reduce the signaling load at the call control functional unit. In particular, the service execution functional unit and the service execution management functional unit may be provided as separate entities at another service architecture layer than the call control functional unit. Thereby, the call control layer and the service execution layer may involve independently as long as their are compatible interfaces between the two layers.

The invoking step may comprise invoking at least two service execution functional units in a serial or parallel manner to integrate services to obtain the service. This provides the advantage that more complex and meaningful services can be generated without recreating services.

Furthermore, the service scripts may be stored at a script database arranged at allocation separated from the service execution functional units. Due to the separate arrangement of the database, a plurality of service execution functional units may be controlled by the service scripts stored in the central database, to thereby reduce signaling load.

A user interaction functional unit may be provided for enabling a user to create or configure the service script. The service script is then generated at a service management server based on information received from the user interaction functional unit. Thereby, an independent function is provided for the user to create or configure its own service scripts without knowledge of the actual service logic provided at the service execution functional units.

The service script may comprise a service triggering information defining trigger conditions for the controlling step. The service description and service triggering information may be coded e.g. in an XML-like language.

In particular, the service description may comprise at least one of a service identification, an IP address of an external execution environment of the service execution functional unit, an IP address of an external repository server, and a module information if the user-specific server is comprised of multiple modules. Thus, the service description provides details of the service subscription of the user and the location and execution of the service.

Furthermore, the service script may be divided into a plurality of script areas including service packages. In particular, the script areas may comprise user script areas for user defined services and service provider script areas for service provider services. Such a script splitting provides the advantage that services can be provided by the operator as a service package adapted to the user needs. Specific user defined services can be provided in the user script area. Then, a priority may be given to user defined services over the service provider services, or may be allocated to the service scripts e.g. based on their type. Thereby, individual user needs can be considered.

The kind of service used in the priority allocation solution of the above object may comprise a universal service assigned to all subscribers of a service provider network, a subscription group service assigned to all subscribers within a certain user group, a user service assigned to one or several subscribers by a user, and an operator service assigned to one or several subscribers by a network operator. In this case, a service script defining a subscription group service may be stored in a database together with a group identification and a priority information defining the execution priority of the subscription group. Thus, predetermined overriding capabilities can be allocated to individual subscription groups. Moreover, interactions between different kinds of scripts can be avoided by the prioritizing. This is required to prevent contacts of the creation or modification of a particular scripts on other existing services in other scripts. The definition of a certain service in one script must also allow the definition and execution of a service in a different script unless the other service is intended to be overridden.

Additionally, a higher priority may be allocated to a service script of a universal service and a lower priority to a service script of a user service. Thus, the universal service has always priority over the subscription group and user services. The higher priority scripts define services that are applicable to a large number of users and therefore those services should be activated based on higher level triggers.

Preferably, a service script is loaded based on the execution priority, when a predetermined trigger condition is met. Than, it is checked whether the trigger condition is defined in the loaded service script, and a new service script with a lower priority is loaded if the trigger condition has not been defined. To achieve an overriding function, a flag may be set in the service script to indicate an overriding status for a particular trigger, said overriding status defining whether service scripts with lower priorities are to be executed or not. Thus, a simple overriding concept can be provided for enabling a user or network operator to define overriding capabilities of predetermined service scripts.

The service execution management means may be arranged to control the service execution means based on the priority allocated to the service script.

### BRIEF DESCRIPTION OF THE DRAWINGS

In the following, the present invention will be described in greater detail on the basis of a preferred embodiment with reference to the accompanying drawings, in which:

FIG. 1 shows a schematic diagram of a network architecture comprising a service architecture according to the preferred embodiment of the present invention,

FIG. 2 shows a schematic block diagram of a service execution manager function according to the preferred embodiment,

FIG. 3 shows a diagram indicating different script templates provided by a service provider,

FIG. 4 shows a complete service script with separate script areas,

FIG. 5 shows an example of a universal script, and

FIG. 6 shows an example of a subscription group script.

### DESCRIPTION OF THE PREFERRED EMBODIMENT

The preferred embodiment will now be described on the basis of an IP-based service architecture for promoting an integration of IP-based services over an access independent IP-based network, particularly a SIP mobile network.

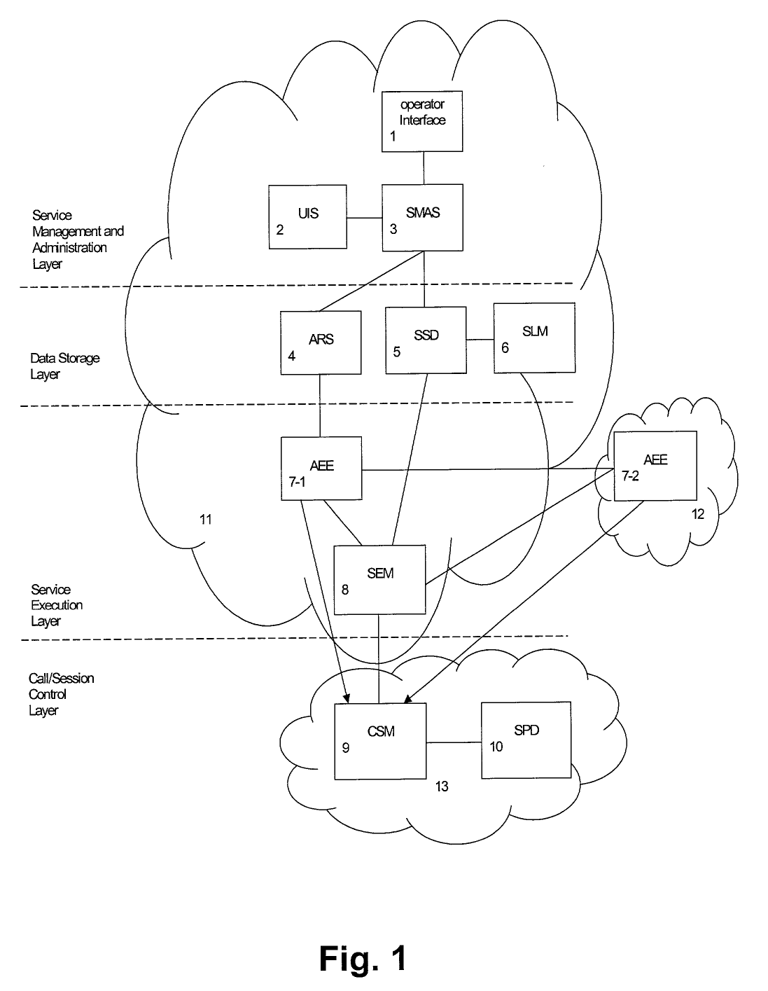

FIG. 1 shows a network architecture comprising an IP-based service architecture (IPSA) 11 arranged as a SIP (Session Initiation Protocol) based application server system to create, manage and execute real-time multimedia services. The IPSA 11 is arranged to serve third generation core networks or other access networks. The IPSA 11 is connected to a communication network such as a PLMN (Public Land Mobile Network) 13 comprising a call/session manager 9 which may be any type of call processing server (CPS), and a subscriber profile database 10, such as a home subscriber server (HSS) or a home location register (HLR). The subscriber profile database 10 is arranged to maintain all static subscription related information which is not related to services provided by the IPSA 11. In particular, the subscriber profile database stores a user identity (UID), aliases, user preferences (e.g. preferred media) and/or the identity of an IPSA service provider. Optionally, it may store a user identity used in the IPSA 11 if the user has a specific identity different from the UID, the scope of which is restricted to the IPSA 11.

The call/session manager 9 may be a SIP server performing SIP call control functions for SIP users. The call/session manager 9 can be any SIP server in the Internet or a CSCF (Call State Control Function) in a third generation UMTS network. The call/session manager 9 handles SIP level interactions with the user, particularly UE (User Equipment) registrations and cancellations, and session modifications and terminations. It is noted that a plurality of call/session managers 9 and/or subscriber profile databases 10 may be provided in the PLMN 13.

The IPSA 11 comprises a service script database 5 in which all service related information is stored, e.g. service scripts, registered services of the operator and third parties. A service location manager 6 is provided to maintain a table of associations between a service execution manager 8 and active users. It has access or an interface to resource information within the IPSA 11. Upon a query, the service location manager 6 returns an active service execution manager address to a requesting entity for a particular user. If a service execution manager has not been allocated yet, an IPSA resource broker (not shown) is queried to obtain probable service execution manager candidates. Due to the fact that the service location manager 6 stores the relationships or associations between active users and service execution managers, the service script database 5 requires the service location manager 6 to get the address of the service execution manager in order to push service execution manager script updates.

Furthermore, the IPSA 11 comprises at least one service execution manager 8 which is invoked by the call/session manager 9 at registration and service invocation. The service execution manager 8 initiates terminations to all the service executions upon session termination indication from a call/session manager 9 according to the corresponding service script. In particular, a single service execution manager handles both mobile-originated and mobile-terminated services for a user.

Additionally, an application repository server 4 is arranged to store the service code or logic for implementing services. The service logic can be transferred from the application repository server 4 to an application executing engine 7-1 either offline or dynamically during service invocation. Optionally, the application repository server 4 may implement administrative functions to test the logic, correctness and solidity of the service code or logic. The application executing engine 7-1 provides a platform for the execution of services when invoked by the service execution manager 8. The platform is capable of providing a secure, robust execution environment for different forms or languages of logic (e.g. Java, CPL, XML, CGI). It generates charging information for using specific services.

The definition of the services is performed by a service manager server 3 which provides an environment where services are defined and the corresponding script information and service logic is created, and performs service management and customization for the subscribers. Users may access the service manager server 3 by using a user interaction server 2 which is a front-end interface provided to the user by the ISPA 11 in order to allow the user to perform service interactions such as service activation, deactivation and modification. When a user accesses the user interaction server 2, the user interaction server 2 is capable of fetching the user's service information from the service manager server 3. Additionally, an operator interface 1 is provided for enabling a network operator to create or modify service scripts.

As indicated in FIG. 1, the application executing engine 7-1 of the IPSA 11 may be connected to an application execution platform or engine 7-2 of a third party service provider network 12. Thereby, integrated services operated by the IPSA 11 and the third party service provider network 12 can be provided to the call/session manager 9.

Thus, the IPSA 11 provides a layered service architecture solution independent from the core network PLMN 13. The layered service architecture can be divided into a service management and administration layer comprising the user interaction server 2, the operator interface 1 and the service manager server 3, a data storage layer comprising the application repository server 4, the service script database 5 and the service location manager 6, a service execution layer comprising the application executing engine 7-1 and the service execution manager 8, and a call/session control layer comprising the call/session manager 9 and the subscriber profile database 10. As long as there are compatible interfaces between the layers, they can evolve independently to thereby provide a high degree of flexibility.

The PLMN 13 sees the IPSA 11 as a service cloud and forwards the session initiations to the IPSA 11 in order to invoke corresponding services. In particular, the PLMN 13 or core network only knows the entry point to the respective service execution manager 8 of the IPSA 11. In the IPSA 11, the service logic is executed in the application executing engine 7-1 and the service execution manager 8 acts as a service manager or conductor in coordinating different service executions.

A service script is defined as a script which has service subscription details of the user and also provide details on where to locate and execute the service. However, the service script does not include any service logic. Thereby, no restrictions on how the service logic can be implemented are posed, and the service logic can be implemented in any language or form and is not limited to particular scripts. Thus, a lower level and powerful programming language can be used for the service logic.

The application executing engine 7-1 necessarily has to be a call processing server and the services can take various forms and may use various protocols supported by the IPSA 11. Thus, services may be provided even by a third party application execution engine 7-2 which does not have to be a call processing server. Due to the fact that any service can be executed in the application executing engine 7-1, application executing engines can be invoked in a serial or parallel fashion to integrate services to generate more complex and meaningful services without the need to recreate services.

Thus, the IPSA 11 defines a completely separate functional element for service management within the operator's network, wherein the service script database 5 is separated from the application servers. In particular, the IPSA 11 provides an access independent architecture which may be used in any communication network, e.g. WLAN (Wireless Local Area Networks), Bluetooth, GPRS (General Packet Radio Services), CDMA2000 (Code Division Multiple Access 2000) etc.

When a new user equipment is registrated in the PLMN 13, a SIP register message is routed to the call/session manager 9 which obtains the corresponding subscriber profile from the subscriber profile database 10 and routes the SIP register message to the corresponding service execution manager 8 of the IPSA 11. The service execution manager 8 supplies the SIP register message to the service script database 5 which response with a 200 OK message comprising the corresponding service script allocated to the concerned subscriber. This service script is temporarily stored at the service execution manager 8 and the 200 OK message is sent to the call/session manager 9 to acknowledge the registration. The service script is removed or deleted from the service execution manager 8 during a de-registration or cancellation of the subscriber.

In case of any relevant event noticed by the call/session manager 9, a call routing to the service execution management 8 is initiated and the service execution manager 8 runs the service script temporarily stored therein. It is noted that there is no need to maintain the relation between the call state of the main call and the calls generated by the IPSA 11. For the call/session manager 9, all calls are simple unrelated calls. Thereby, the complexity in the call/session manager 9 can be reduced.

Based on the information given in the service script, the service execution manager 8 performs a service invocation to the internal application executing engine 7-1 and/or the external application executing engine 7-2 which provides a corresponding service information to the service execution manager 8 or invokes parallel services at other application executing engines, such that the desired service functions are provided to the call/session manager 9 or any other required call/session manager.

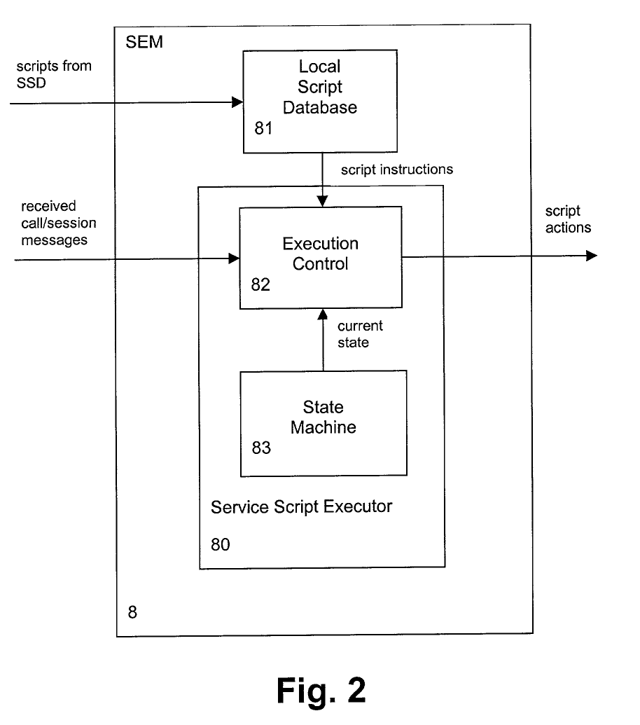

FIG. 2 shows a schematic block diagram of the service execution manager 8. According to FIG. 2, the service execution manager comprises a local script database 81 for temporarily storing user scripts of active subscribers after their registration, and a service script executor 80 for loading and executing a service script stored in the local script database 81. Furthermore, the service script executor 80 comprises an execution control function 82 and a state machine function 83, wherein the execution control function 82 is arranged to compare instructions of the service script loaded from the local script database 81 with a received call or session control message from the call/session manager 9 or the application executing engine 7-1. The result of the comparison indicates what call control message or messages have to be issued to the application executing engine 7-1 or the call/session manager 9, and what the next state of the state machine function 83 is. Thus, the execution control function 82 receives instructions from the concerned service script, a received call or session control message and a current state of the state machine function 83. The execution control function 82 compares the script instructions to the received call or session control message. If the result matches with the received message, actions defined in the service script are performed, i.e. messages are sent out, and the state machine function 83 moves to the next state defined in the script. As already mentioned, the service scripts temporarily stored in the local script database 81 are downloaded or pushed from the service script database 5.

It is noted that the service script executor 80 may be implemented by a processing device controlled on the basis of a control program. Thus, the execution control function 82 and the state machine function 83 may be based on corresponding software routines.

To provide a higher level flexibility and allow services and service settings, a service script concept is provided. To achieve this, the user interaction server 2 provides means for creating and configuring services, e.g. a user may combine graphical service building blocks provided by the user interaction server 2 and creates a meaningful service. This may be achieved by corresponding input/ouput facilities such as a keyboard or pointing device and a display of the user equipment. Based on the information received from the user interaction server 2, the service management server 3 generates a user service script, wherein service description and triggering information may be coded in the script using some XML-like language. The script generation process may be automatic. Generated service scripts are statically stored in the service script database 5. Script updates are pushed to the local script database 81 of the service execution manager 8 if the local script database 81 has an older version of the script.

A service description contains information on e.g. a service ID, an ID address of an external execution environment, an IP address of an external repository server, and/or a module information if the service comprises multiple modules. The service triggering contains the triggering conditions for service invocation. A simple service script may consist of a script header which may define a user identification, a service provider identification, and/or a number of services. In a service description portion, a service name, service ID, service provider identification and/or service execution address may be indicated. Finally, a trigger portion may be provided defining a trigger condition or trigger event.

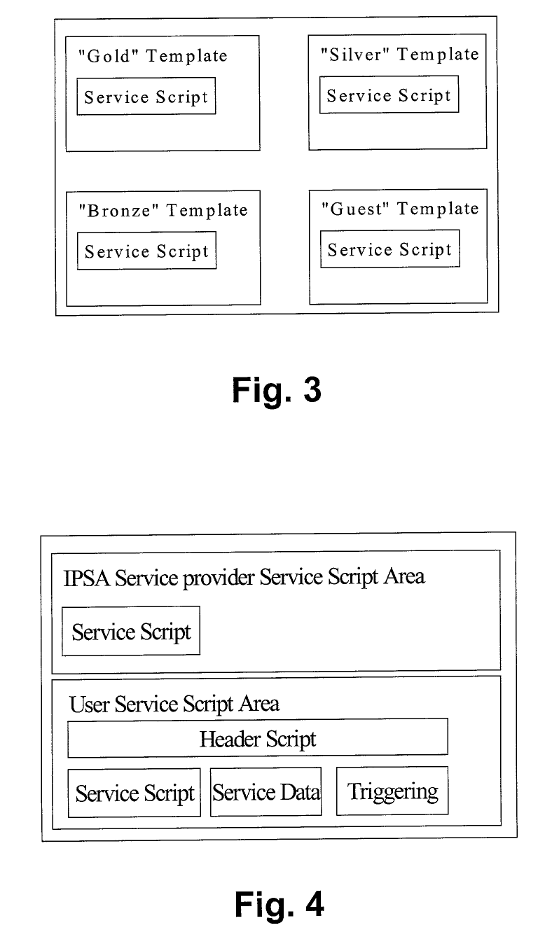

Due to the fact that not all services are user created, the operators may provide a lot of services as a package. According to FIG. 3, a “gold template”, “silver template”, a “bronze template” and a “guest template” are provided which define different service packages based on individual needs of a user or predetermined default or basic service requirements. In particular, the “gold template” may provide an enhanced range of services, while the “guest template” only provides a minimum range of services. The “silver template” and the “bronze template” may provide respective reduced packages of services. Based on the number or variety of services in the package, the charging may be adapted. Thus, the templates can be selected by the user to obtain a predefined service script with a predefined package of services.

Additionally, the service script may be split into different service script areas. Such a script splitting may be useful, since users do not have any defined service scripts at the time of subscription. Thus, certain scripts have to be provided by the service provider. A service script area defines a predetermined set of services. As indicated in FIG. 4, a service provider script area and a user service script area may be provided. The service provider script area cannot be changed by the user. It may comprise templates as indicated in FIG. 3 to thereby assure a basic or initial range of services. All user defined services are placed into the user service script area. The service script areas must be flexible enough to accommodate different service configurations and service data. Furthermore, to prevent any disruption of signallings, a possibility to override the service provider services by the user defined services may be established. This could be performed by introducing a priority rule in the execution control function 82.

Thus, the script itself can be divided into multiple script areas which include service packages. As can be gathered from FIG. 4, the user service script areas comprises a header script, a service script, service data and triggering information.

Furthermore, a plurality of different service kinds with different priorities may be defined as follows.

A universal service may be defined as a service assigned to all subscribers in a service provider's network and created by the operator. As an example, such a universal service could be a seasonal greeting, e.g. a text “Merry Christmas” with a picture of Santa Claus, when the subscriber opens the terminal at a predetermined time of the year.

Furthermore, a subscription group service may be defined as a service applicable to a specific set of subscriptions. The subscription group service is a service assigned to all subscribers within a certain user group. It is created by the operator and this could be for example a calling plan service, wherein the operator may want to apply some services only to all users of a specific spatial region or plan (e.g. “National Roaming 600” or “Regional Roaming 300” or “Basic Calling 75” in the USA).

Furthermore, a user service may be defined as a service assigned to one or several subscribers by a user through the user interaction server 2, and an operator service may be defined as a service assigned to one or several subscribers by the operator through the operator interface 1. It is noted that the universal services and subscription group services are operator services.

Accordingly, universal scripts are used to control universal services, subscription group scripts are used to control subscription group services, and user scripts are created by users and/or the operator and may be used to control user services and operator services.

Thus, the service script database 5 may contain for every subscriber an IPSA user ID, one or several subscription group IDs, and a user script. A user may belong to one or a plurality of subscription groups, or to no subscription group. The service script database 5 may also contain a database for subscription groups, in which a subscription group ID, a subscription group script, and a priority information (e.g. 1 to 100) is stored. Furthermore, a universal script common to all subscribers in the service provider's network may be stored in the service script database 5. However, it is noted that the universal scripts not necessarily have to be stored in the service script database 5, since they are common to all subscribers.

As already mentioned, the service scripts are loaded to the local script database 81 of respective service execution managers assigned to the respective subscribers. The universal and subscription group scripts may be pre-loaded into the corresponding service execution managers independent of the user registrations. Thereby, signaling load can be reduced. This is justified, since these service scripts do not change very often. However, in case of a change, the service manager server 3 may update these scripts in all relevant service execution managers of the service provider's network.

In the following, a prioritizing scheme for the script management and execution by the execution control function 82 is described. The prioritizing scheme provides the advantage that interactions between different kinds of scripts are avoided. This is necessary, because the creation or modification of a particular script must not have any unintentional impact on other existing services in other scripts. Furthermore, the services defined for groups (i.e. universal services and subscription group services) could get a higher priority to be executed before the user scripts are executed. Additionally, it is required that the definition of a certain service in one script also allows the definition and execution of a service in a different script, unless the operator intends to override the other services.

According to the prioritizing scheme, service scripts could be executed in the following order given highest priority to the universal script:

Universal script→subscription group script of priority 1→subscription group script of priority 2→ . . . →subscription group script of priority N→user script.

In this example the universal service always has a higher priority than the subscription group and user services.

In addition to the prioritization, it is required that the definition of a certain service at a higher priority script must not preclude the definition and execution of a service at a lower priority script. However, there may be cases where the operator may want to override the services defined in the lower priority scripts. This means, that lower priority services are inhibited by higher priority services. This may be achieved by defining an overriding capability in the higher priority scripts. The overriding scheme may be performed as follows.

The scripts are loaded and executed by the execution control function 82 of the service execution manager 8 when predetermined conditions are met. These triggering conditions are predefined in the service scripts to trap the trigger and initiate particular services. It is noted that not all triggers need to be defined in the service script, but only the specific triggers required to initiate the defined services. In addition, it is possible that the same trigger is defined in more than one script. When a particular trigger condition is met, the execution control function 82 loads the scripts from the local script database 81 based on their priority and checks if the trigger is defined. If it is not defined, the execution control function 82 loads a script of a lower priority and so on. If a trigger is defined, the corresponding service is initiated by the execution control function 82.

In order to facilitate overriding, a flag indicating the overriding status of a particular trigger may be provided in the service script. If the overriding flag indicates “OFF”, then the next lower priority script is loaded and checked for the same trigger definition at the end of execution of the service of the current script. However, if the overriding flag is “ON”, the next lower priority scripts are not executed for that particular trigger.

Usually, higher priority scripts define services that are applicable to a large number of users and therefore those services are activated on higher priority level triggers. Furthermore, it is not recommendable to create complex triggering and services to universal or subscription group services, since the interaction between them and the user services is undefined and unknown. Problems may occur if e.g. a universal service modifies the calling party address, and the user service triggers based on that information.

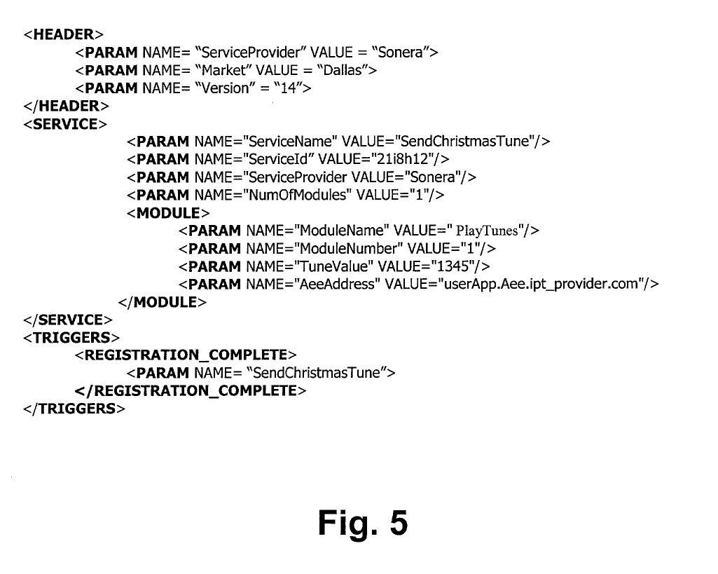

FIG. 5 shows an example of a universal script for the service provider “Sonera” in the Dallas environment. According to this universal service, a Christmas tune is sent after the registration is completed.

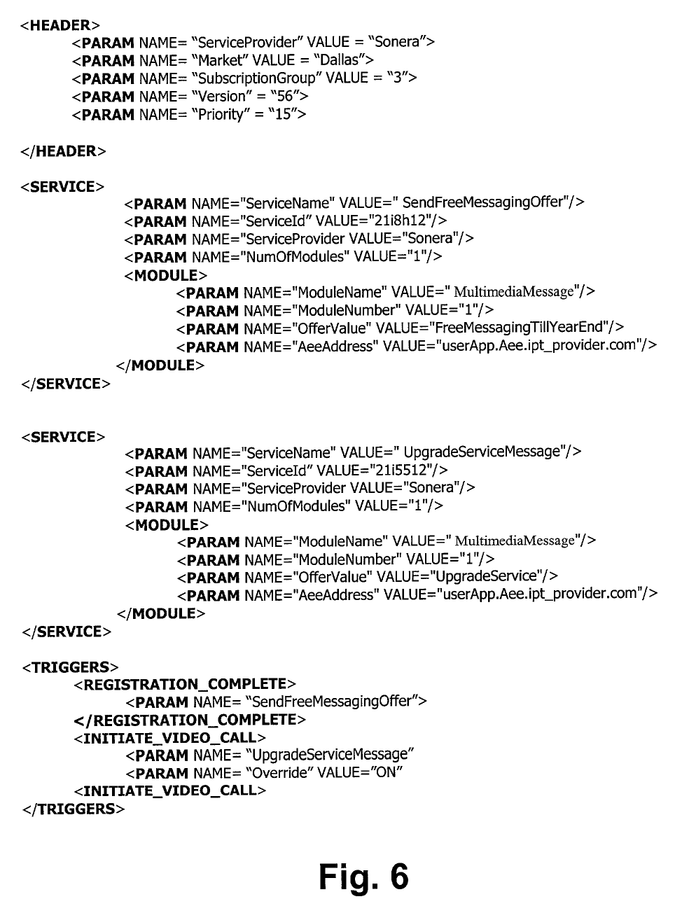

FIG. 6 shows an example for a subscription group script for a subscription group of a value “3” and a priority “15” of the above service provider and market. According to this subscription group script, the trigger is trapped and overridden when a video call is initiated, because this is a basic subscription group and premium services are not offered in this plan. User scripts are not run for the “INITIATE_VIDEO_CALL” trigger anymore, because the overriding flag is set to “ON”.

It is noted that the present invention is not restricted to the preferred embodiment described above, and can be applied to any service architecture. In particular, any priority may be allocated based on the kind of service script. Thus, the preferred embodiment may be varied within the scope of the attached claims

1. A method for providing a service in a communication network (13), said method comprising the steps of:
a) generating a service script comprising a service description of said service;
b) providing a service logic of said service at a service execution functional unit (7-1, 7-2); and
c) controlling said service execution functional unit (7-1, 7-2) based on said service description to execute said service by using said service logic.

2. A method according to claim 1, further comprising the step of storing said service script at a service execution management functional unit (8), routing a call from a call control functional unit (9) to said execution management functional unit (8), and invoking said service by said service execution management functional unit (8) based on said service description.

3. A method according to claim 2, further comprising the step of providing said service execution functional unit (7-1, 7-2) and said service execution management functional unit (8) as separate entities at another service architecture layer than said call control functional unit (9).

4. A method according to claim 2, wherein said invoking step comprises invoking at least two service execution functional units (7-1, 7-2) in a serial or parallel manner to integrate services to obtain said service.

5. A method according to claim 1, further comprising the step of storing said service script at a script database (5) which is arranged at a location separated from said service execution functional unit (7-1, 7-2).

6. A method according to claim 1, further comprising the step of providing a user interaction functional unit (2) for enabling a user to create or configure said service script.

7. A method according to claim 6, further comprising the step of generating said service script at a service management server (3) based on information received from said user interaction functional unit (2).

8. A method according to claim 1, wherein said service script comprises a service triggering information defining trigger conditions for said controlling step.

9. A method according to claim 8, wherein said service description and service triggering information is coded in an XML-like language.

10. A method according to claim 1, wherein said service description comprises at least one of a service identification, an IP address of an external execution environment of said service execution functional unit (7-1, 7-2), an IP address of an external repository server (4), and a module information.

11. A method according to any one of the preceding claims, wherein said service script is divided into a plurality of script areas including service packages.

12. A method according to claim 11, wherein said script areas comprise user script areas for user defined services and service provider script areas for service provider services.

13. A method according to claim 12, wherein a priority is given to said user defined services over said service provider services.

14. A method according to claim 12, wherein a priority is allocated to said service scripts based on their type.

15. A method for providing a service in a communication network, said method comprising the steps of:
a) generating a service script defining said service;
b) controlling a service execution functional unit (7-1, 7-2) based on said service script to execute said service, and
c) allocating an execution priority for said service script based on the kind of service.

16. A method according to claim 15, wherein said kind of service comprises a universal service assigned to all subscribers of a service provider network, a subscription group service assigned to all subscribers within a certain user group, a user service assigned to one or several subscribers by a user, and an operator service assigned to one or several subscribers by a network operator.

17. A method according to claim 16, further comprising the step of storing a service script defining a subscription group service in a database (5) together with a group identification and a priority information defining the execution priority of the subscription group.

18. A method according to claim 16, further comprising the step of allocating a higher priority to a service script of a universal service and a lower priority to a service script of a user service.

19. A method according to claim 15, further comprising the step of loading a service script based on said execution priority, when a predetermined trigger condition is met, checking whether said trigger condition is defined in said loaded service script, and loading a new service script with a lower priority if the trigger condition has not been defined.

20. A method according to claim 15, further comprising the step of setting a flag in said service script to indicate an overriding status for a particular trigger, said overriding status defining whether service scripts with lower priorities are to be executed or not.

21. A system for providing a service in a communication network (13), said system comprising:
a) generating means (3) for generating a service script comprising a service description of said service;
b) service execution means (7-1, 7-2) comprising a service logic for executing said service; and
c) service execution management means (8) for controlling said service execution means (7-1, 7-2) based on said service description to execute said service by using said service logic.

22. A system according to claim 21, further comprising call control means (9) for routing a call to said service execution management means (8), wherein said service execution management means (8) is arranged to invoke said service at said service execution means (7-1, 7-2) based on said service description.

23. A system according to claim 21, wherein said service execution means (7-1, 7-2) and said service execution management means (8) are arranged as separate entities at another service architecture layer than said call control means (9).

24. A system according to claim 21, further comprising a service script database (5) for storing said service script, said service script database (5) being arranged as a central database separated from said service execution means (7-1, 7-2).

25. A system according to claim 1, wherein said system is arranged as a service network (11) separated from said communication network (13).

26. A system according to claim 21, wherein said service execution management means (8) is arranged to control said service execution means (7-1, 7-2) based on a priority allocated to said service script.

27. A system for providing a service in a communication network (13), said system comprising:
a) generating means (3) for generating a service script comprising a service description of said service;
b) service execution management means (8) for controlling service execution means (7-1, 7-2) based on said service description to execute said service; and
priority allocating means (82) for allocating an execution priority to said service script based on the kind of said service.
